(19) United States
(12) Patent Application Publication
(10) Pub. No.: US 2025/0198526 A1
(43) Pub. Date: Jun. 19, 2025

(54) A SHUT-OFF VALVE FOR A FLUID

(71) Applicant: CAVAGNA GROUP S.P.A., Calcinato (IT)

(72) Inventor: Savio Cavagna, Calcinato (IT)

(73) Assignee: CAVAGNA GROUP S.P.A., Calcinato, OT (IT)

(21) Appl. No.: 18/847,139

(22) PCT Filed: Mar. 15, 2023
(86) PCT No.: PCT/IB2023/052499

§ 371 Date: Sep. 13, 2024

(30) Foreign Application Priority Data
Mar. 15, 2022 (IT) 102022000005015

(51) Int. Cl. F16K 17/04; F16K 17/36

(52) U.S. Cl. CPC F16K 17/0486; F16K 17/36

(57) ABSTRACT

A shut-off valve for a fluid includes a valve body having a discharge channel with an interception zone arranged between the inlet and the outlet. A closure device is movable between open and closed positions. An oscillating group is configured to abut the closure device, maintaining it in the open position, when it is in the rest position, and to allow a translational movement of the closure device into the closed position when it is in the safety position. The oscillating group is configured to be moved from the rest position to the safety position when the inertial mass is subjected to a lateral acceleration greater than a predefined value.

The present invention relates to a shut-off valve for a fluid, of the type intended for intercepting liquid or gaseous substances on-board vehicles or other systems during movement.

During the use of dangerous fluids on-board vehicles and/or during the travel of vehicles themselves, there may occur incidents which can lead to an uncontrolled discharge of the dangerous fluids, with potentially disastrous effects both for people and for the environment.

This is the case, for example, with caravans and motorhomes which typically have a cooking and heating system and often also a refrigerator which are supplied by a gas bottle.

For these vehicles, the use of equipment items which use such a gas while they are moving is allowed only if the gas distribution system is provided with a safety system which interrupts the flow of the gas in the event of incidents so as to contain possible damage caused by the discharge of the gas itself.

There are known in the art different safety devices for stopping the discharge of fluids from tanks and bottles in the case of incidents, including for vehicles such as motorhomes and caravans.

EP2096340 A1 relates to a safety valve having a ball which is normally arranged in a concave seat which has suitable dimensions at the bottom of the valve itself and which cooperates in this position with a spring, by maintaining it in a state blocked in position so that the valve remains open. Following an impact, the ball leaves its seat and unblocks the spring, with a resultant closure of the valve. This device is relatively complex and, as such, is subject to possible malfunctions and further needs very small tolerances during design and considerable impacts in order to make the ball leave the seat and therefore to make the valve change from the open position to the closed position.

EP3822524 A1 sets out a safety valve having a closure device which can move between two positions, open and closed. In the open position, the closure device has a valve pin in unstable equilibrium on a head of an inverted pendulum which is arranged on a bearing in such a manner that it is in alignment with the closure device itself and is normally maintained in this position by the pendulum itself. In particular, the pendulum head has a small projection, on which the valve pin is in unstable equilibrium and a channel which is positioned around it. Following an impact, the inverted pendulum moves so that it is no longer in alignment with the closure device which is thereby free to move into the closed position, preventing the flow of the fluid. During the movement into the closure position, the pin of the valve engages in the channel of the head of the inverted pendulum.

This device also has a number of critical states. In particular, it requires mechanical processing operations which are very precise; furthermore, because the head of the pendulum is arranged in the path of the fluid, it may be affected by the type of fluid and flow variations of the fluid itself or potential particles present in the fluid which can bring about an undesired actuation or generally a malfunction of the valve itself. To this end, in fact, this device provides a reset system so as to reset the valve in the open configuration again.

Additional safety devices for valve groups have been developed in the context of preventing damage resulting from earthquakes. Examples of such solutions are described in EP 1473494 A1, JP S53 79427 U, JP S48 76518 U and JP S48 68166 U.

Therefore, the problem addressed by the present invention is to provide a shut-off valve for fluids which is structurally and functionally configured to at least partially overcome one or more of the disadvantages set out with reference to the cited prior art.

Another object is to provide a shut-off valve for fluids which is reliable, robust, economical and simple to construct and which at the same time responds rapidly to accelerations, which occur, for example, in the case of incidents, beyond a specific predetermined value.

This problem is solved and one or more of these objects is/are at least partially achieved by the invention according to a first aspect thereof by means of a shut-off valve for fluids comprising one or more of the features mentioned in the appended claims.

The shut-off valve for fluids of the present invention comprises a valve body comprising a discharge channel for the fluid, comprising an inlet for the fluid, an outlet for the fluid and an interception zone which is arranged between the inlet and the outlet.

The shut-off valve further comprises a closure device which is at least partially arranged in the interception zone and which is movable along an axis X between an open position, in which a passage of fluid is allowed between the inlet and the outlet, and a closed position, in which the passage is prevented.

In the closed position, therefore, the flow of the fluid in the discharge channel is stopped and consequently the fluid cannot be discharged in an uncontrolled manner downstream of the shut-off valve, for example, in a distribution line of the fluid positioned downstream of the shut-off valve.

Preferably, this closure device is rotationally symmetrical with respect to this axis X.

Preferably, the closure device is urged to close, for example, by gravitational force. Alternatively or additionally, the closure device is urged to close by means of a suitable actuator.

The shut-off valve further comprises an oscillating group comprising a rod and an inertial mass which is secured to the rod in such a manner that the rod has at least one free end.

Preferably, the oscillating group is secured in a pivoting manner to the valve body by means of a joint, the joint being configured so as to separate the interception zone from a receiving chamber, in which the inertial mass is housed, keeping it outside the interception zone.

Preferably, the oscillating group is supported in terms of pivoting with respect to the valve body by means of the joint between a rest position, in which the rod is arranged along the axis X, and a safety position, in which the rod is inclined with respect to the axis X.

Preferably, the oscillating group is configured so as to abut the closure device, maintaining it in the open position, when the oscillating group is in the rest position, and to allow a translational movement of the closure device into the closed position when the oscillating group is in the safety position, the oscillating group being configured so as to be moved from the rest position to the safety position when the inertial mass is subjected to a lateral acceleration greater than a predefined value.

This acceleration can act equally well on the shut-off valve directly or on a system of a superior level, such as a vehicle, in which this shut-off valve is installed.

This predetermined value may be, for example, the one which occurs in the case of collisions or incidents in general.

This predetermined value may be, for example, equal to a value of 2 G.

The person skilled in the art is able to establish this predetermined value and consequently to design the shut-off valve in the context of the normal design activity so as to prevent the shut-off valve from interrupting the flow of the gas as a result of small lateral accelerations which cannot be attributed to dangerous situations and which do not interrupt the flow of the gas in dangerous situations.

In particular, the person skilled in the art will be able to design the length of the rod, the form and the weight of the inertial mass, the position of the joint and the materials and the relevant frictions in the context of the normal design activity.

According to a second aspect, the invention also relates to the use in a vehicle of a shut-off valve, comprising one or more of the features mentioned above for intercepting a fluid following an impact which is generated following a collision of the vehicle as a result of an incident.

The present invention in at least one of the above-mentioned aspects may also have one or more of the following preferred features, in addition to the ones mentioned above.

Preferably, the inertial mass has a weight between 20 and 80 g, more preferably between 30 and 50 g.

With an inertial mass having a weight in this range, it has been found that the shut-off valve has ideal behaviour.

In the context of the present description, the expressions “closed position” and “closure position” are used interchangeably.

In a generally similar manner, the expressions “open position” and “opening position” are intended to be considered to be interchangeable.

It will be appreciated that the shut-off valve of the present invention has an oscillating group, the inertial mass of which is not affected by the flow of the fluid or the variations thereof, not being covered by the fluid itself.

In this manner, the same inertial mass functions in a virtually similar manner both with gases and with liquids, and particularly both with dense liquids and/or viscous liquids and with low-density liquids and/or low-viscosity liquids.

This inertial mass is further unaffected by the presence of particles or generally impurities which may be present in the fluid, whether it is a gaseous or liquid fluid.

Furthermore, this valve is structurally simpler than the prior art and therefore generally less subject to malfunctions, undesirable actuations and wear.

Finally, this valve has an operating system which allows greater processing tolerances of the pendulum body than in the prior art.

Preferably, the joint is configured so as to separate the discharge channel from the receiving chamber, in which the inertial mass is received, keeping it outside the discharge channel.

In this manner, the operation of the valve is made even more independent of the fluid.

Preferably, the joint is at a pivot location positioned between the free end of the rod and the inertial mass.

In some embodiments, the interception zone of the valve body comprises a valve seat and the closure device comprises a valve head which is arranged in the discharge channel and which is movable between a position spaced apart from the valve seat when the closure device is in the open position, and a position in which the valve head is engaged in a sealing manner with the valve seat when the closure device is in the closed position.

Preferably, the valve head is arranged in the discharge channel upstream of the valve seat.

This arrangement further promotes the closure of the valve and therefore the interruption of the flow of the gas, generally increasing the safety of the valve itself.

Alternative embodiments are further possible, wherein the valve head is arranged in the discharge channel downstream of the valve seat.

The expression “upstream” is intended to be understood to be the fluid discharge channel portion which is positioned between the inlet and the valve seat, while the expression “downstream” is intended to be understood to be the discharge channel portion which is positioned between the valve seat and the outlet.

In one embodiment, the valve head and/or the valve seat comprise at least one resilient sealing element.

Advantageously, this improves the fluid-tightness of the valve head itself on the valve seat.

Preferably, this resilient element is an annular fluid-tight seal, more preferably this annular fluid-tight seal is supported on the valve head.

In some embodiments, the closure device comprises a pin which is fixedly joined to the valve head and which is arranged along the axis X and slidingly movable into the interception zone, this pin having a free end in the direction away from the valve head, and the oscillating group is supported in a pivoting manner between the rest position, in which the free end of the rod abuts the free end of the pin, maintaining the closure device in the open position, and the safety position, in which the free end of the rod does not abut the free end of the pin so that the closure device is free to move in translation into the closed position.

It will be appreciated that, on the basis of these features, the closure device and the oscillating group cooperate efficiently because the closure device is maintained in an open position as long as the pin abuts, at an unstable equilibrium location, the free end of the pendulum body.

In some embodiments, the joint is an oscillating joint.

Preferably, the oscillating joint is a ball joint comprising a spherical pin which is fixedly joined to the valve body and a corresponding spherical element which is fixedly joined to the rod and which is arranged along it at a location between the free end of the rod and the inertial mass.

In some embodiments, the free end of the pin is tapered, preferably tapered with a spherical or conical form.

This allows suitable and precise calibration of the abutment surface between the closure device and the oscillating group and the movement of the closure device from the open position to the closed position following the movement of the oscillating group from the rest position to the safety position.

In some embodiments, the free end of the rod is tapered, preferably tapered with a frustoconical form.

It will be appreciated that this technical arrangement also allows suitable and precise calibration of the abutment surface between the closure device and the oscillating group and the movement of the closure device from the open position to the closed position following the movement of the oscillating group from the rest position to the safety position.

In some embodiments, the closure device is urged to close by an actuator.

In some preferred embodiments, the actuator comprises at least one resilient element.

Preferably, this resilient element is a spring, more preferably an expansion spring.

In this manner, the closure device is urged to close in a simple and efficient manner.

In some embodiments, the valve body has an internal abutment and the resilient element is an expansion spring which has an axis arranged along the axis X and which is confined between the valve head and the internal abutment.

In this manner, the expansion spring, by expanding into the space between the valve body and the valve head, not only ensures the movement of the closure device from the open position to the closed position instantaneously as soon as the movement of the oscillating group is carried out from the rest position to the safety position following an acceleration greater than a predefined value, but also ensures that the closure device is also maintained in the closed position if the pendulum body were to tend to return from the safety position to the rest position.

Furthermore, because the spring is confined between the valve head and the internal abutment of the valve body, this results in the shut-off valve being compact and reliable because the spring cannot leave its confinement.

In some embodiments, the closure device comprises a shaft which is arranged along the axis X in the direction away from the valve head at the side opposite the pin and which moves inside the expansion spring.

Advantageously, this also improves the compactness of the valve and the reliability thereof because the closure device can only move in translation with respect to the spring, particularly can only move in translation with respect to the spring along the axis X.

This shaft has a corresponding commutation space inside the valve body, that is to say, a space in which the shaft can move during the movement of the closure group from the open position to the closed position.

In some embodiments, the shaft comprises a shaft portion which is slidingly received in the internal abutment in such a manner that, when the closure device moves between the open and closed positions, the shaft portion slides in the internal abutment.

It will be appreciated how this technical arrangement also improves the compactness of the valve and the reliability thereof because the closure device can only move in translation with respect to the valve body, particularly can only move in translation with respect to the valve body along the axis X.

In some embodiments, the centre of gravity of the inertial mass is located along the axis X when the oscillating group is in the rest position and is located outside the axis X when the oscillating group is in the safety position.

In some embodiments, the inertial mass is rotationally symmetrical with respect to this axis X.

In this manner, the shut-off valve responds homogeneously for an acceleration in any direction.

Preferred features of the invention are more generally defined by the dependent claims.

The features and advantages of the invention will be better appreciated from the detailed description of a number of embodiments thereof which are illustrated, by way of non-limiting example, with reference to the appended drawings, in which:

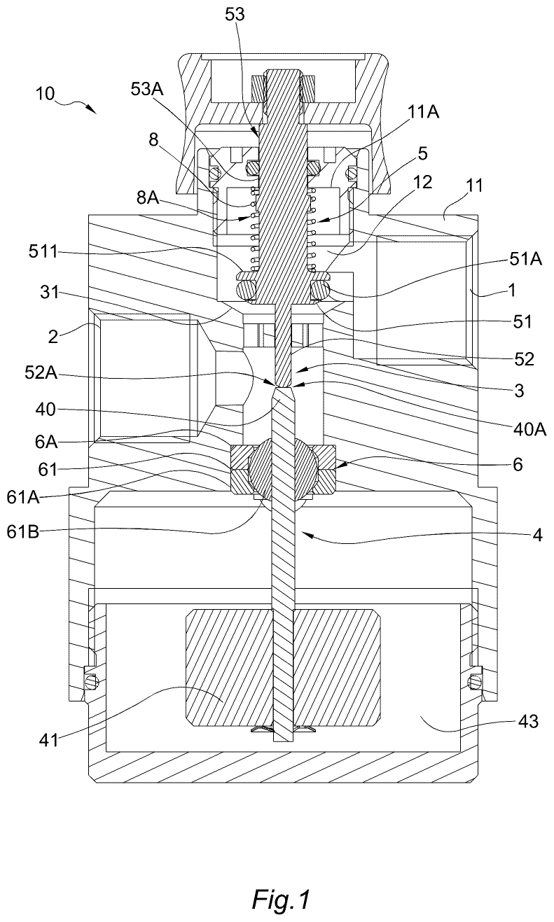

FIG. 1 is a sectional view of the shut-off valve according to the present invention in a first operating configuration; and

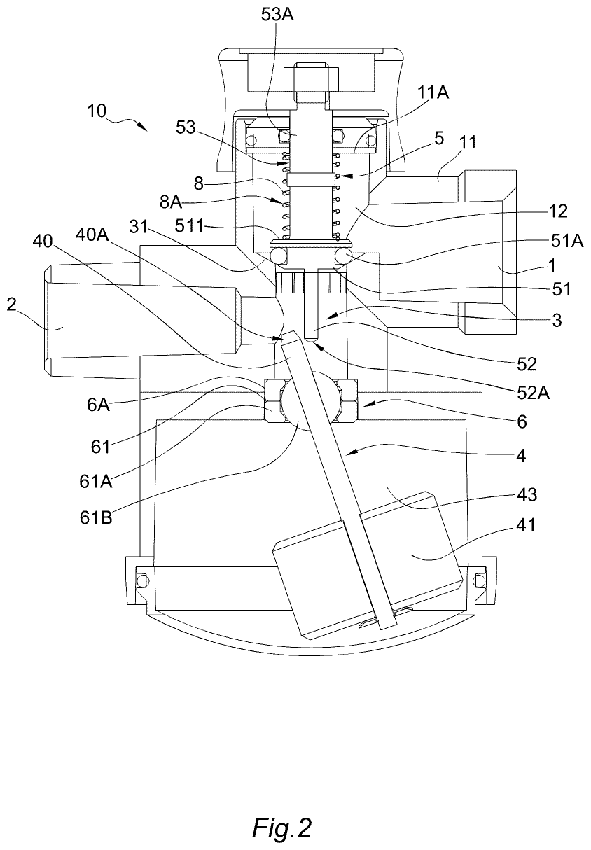

FIG. 2 is a sectional view of the shut-off valve of FIG. 1 according to the present invention in a second operating configuration.

Initially with reference to FIG. 1, a shut-off valve according to the present invention is generally designated 10.

The shut-off valve 10 is intended to be used to interrupt the flow of a fluid along a transport line thereof which is not shown in the Figures.

This fluid may equally well be a liquid or a gas.

Preferably, this fluid is a dangerous fluid, for example, it is a combustible and/or inflammable and/or explosive and/or toxic fluid for people or the environment.

As may be noted from FIG. 1, this shut-off valve 10 comprises a valve body 11 having a discharge channel 12, where the fluid flows between an inlet 1 and an outlet 2.

The valve body 11 further comprises an interception zone 3 which is arranged in the discharge channel 12 between the inlet 1 and the outlet 2 and a receiving chamber 43 which is separated from the discharge channel 12 by means of a joint 6.

With reference to FIG. 1, this joint 6 is a ball joint 61.

The interception zone 3 comprises a valve seat 31.

The shut-off valve 10 further comprises a closure device 5 which is partially arranged in the interception zone 3.

This closure device 5 is movable along an axis X between two positions, an open position, which is illustrated in FIG. 1 and in which the fluid can move between the inlet 1 and the outlet 2 of the shut-off valve 10, and a closed position, which is illustrated in FIG. 2 and in which this movement is inhibited.

The closure device 5 comprises a valve head 51, a shaft 53 and a pin 52 which are all arranged along the axis X.

In particular, the shaft 53 is arranged along the axis X in the direction away from the valve head 51 at the side opposite the pin 52.

The valve head 51, the shaft 53 and the pin 52 are fixedly joined in terms of movement along the axis X between the open position and closed position of the closure device 5 itself.

Particularly when the closure device 5 is in the open position, the valve head 51 is in a position spaced apart from the valve seat 31 while, when the closure device 5 is in the closed position, the valve head 51 is engaged with the valve seat 31 in a sealing manner.

The valve head 51 further comprises an annular fluid-tight seal 51A which is capable of moving into abutment against the valve seat 31 when the closure device 5 is in the closed position.

The pin 52 can move slidingly along the axis X in the interception zone 3 and has a free end 52A in the direction away from the valve head 51.

The closure device 5 further comprises an expansion spring 8A.

The expansion spring 8A is also arranged along the axis X, surrounding a portion of the shank 53 of the closure device 5 and is received between an internal abutment 11A of the valve body 11 and a first surface 511 of the valve head 51, this first surface 511 facing the internal abutment 11A.

The shank 53 has a portion 53A thereof slidingly received in the internal abutment 11A of the valve body 11 in such a manner that, when the closure device 5 moves between the open and closed positions, this shank portion 53A slides in the internal abutment 11A.

The shut-off valve 10 further comprises an oscillating group 4.

This oscillating group 4 comprises a rod 40 and an inertial mass 41 which is secured to the rod 40 in such a manner that it has a free end 40A in the direction away from the inertial mass 41.

The inertial mass 41 is rotationally symmetrical with respect to the axis X.

The oscillating group 4 is secured in a pivoting manner by means of the ball joint 61 to the valve body 11 in such a manner that the rod 40 is at least partially arranged in the interception zone 3 while the inertial mass 41 is external with respect to the interception zone 3.

In particular, the inertial mass 41 is arranged in the receiving chamber 43.

In greater detail, the ball joint 61 comprises a spherical pin 61A which is fixedly joined to the valve body 11 and a spherical element 61B which is fixedly joined to the rod 41 of the pendulum body 4.

The spherical element 61B is arranged along the rod 40 at a location between the free end 40A and the inertial mass 41.

The oscillating group 4 is supported in a pivoting manner by the ball joint 61 between a rest position, in which the rod 40 is arranged along the axis X, as can be seen in FIG. 1, and a safety position, in which the rod 40 is inclined with respect to this axis X, as in FIG. 2.

The centre of gravity of the inertial mass 41 is located along the axis X when the oscillating group 4 is in the rest position while it is located outside this axis when the oscillating group 4 is in the safety position.

The oscillating group 4 is configured so as to be moved from the rest position to the safety position when the inertial mass 41 is subjected to a lateral acceleration greater than a predetermined value.

The oscillating group 4 is further configured so as to abut the closure device 5, maintaining it in the open position, when the oscillating group 4 is in the rest position and to allow a translational movement of the closure device 5 into the closed position when the oscillating group 4 is in the safety position.

Particularly when the oscillating group 4 is in the rest position, the free end 40A of the rod 40 abuts the free end 52A of the pin 52 of the closure device 5, maintaining it in the open position.

When, however, following a lateral acceleration, such as, for example, an impact, having a value greater than a predetermined value, the oscillating group 4 moves from the rest position to the safety position, therefore, the rod 40 is inclined with respect to the axis X, the free end 40A thereof no longer abuts the free end 52A of the pin 52 of the closure device 5, which is therefore free to move in translation along the axis X into the closed position.

When the closure device 5 is in the open position, the expansion spring 8A which is received between the internal abutment 11A of the valve body 11 and the first surface 511 of the valve head 51 is in the compression state.

As soon as the oscillating group 4 moves into the safety position, the translational movement of the closure device 5 into the closed position is promoted and maintained by the expansion of the expansion spring 8A itself.

Naturally, in order to comply with specific and contingent application requirements, a person skilled in the art may apply to the above-described solution additional modifications and variants which are still included within the scope of protection as defined by the appended claims.

1. A shut-off valve for a fluid, comprising:
a valve body comprising a discharge channel for the fluid, comprising an inlet for the fluid, an outlet for the fluid and an interception zone which is arranged between the inlet and the outlet;
a closure device which is at least partially arranged in the interception zone and which is movable along an axis (X) between an open position, in which a passage of fluid is allowed between the inlet and the outlet, and a closed position, in which the passage is prevented; the closure device being urged to close; and
an oscillating group comprising a rod and an inertial mass which is secured to the rod in such a manner that the rod has at least one free end, the oscillating group being secured in a pivoting manner to the valve body by means of a joint, the joint being configured so as to separate the interception zone from a receiving chamber, in which the inertial mass is housed, keeping it outside the interception zone,
the oscillating group being supported in terms of oscillation with respect to the valve body by the joint between a rest position, in which the rod is arranged along the axis (X), and a safety position, in which the rod is inclined with respect to the axis (X);
wherein the oscillating group is configured so as to abut the closure device, maintaining in the open position, when the oscillating group is in the rest position, and to allow a translational movement of the closure device into the closed position when the oscillating group is in the safety position,
the oscillating group being configured so as to be moved from the rest position to the safety position when the inertial mass is subjected to a lateral acceleration greater than a predefined value.

2. The shut-off valve according to claim 1, wherein the closure device is rotationally symmetrical with respect to the axis (X).

3. The shut-off valve according to claim 1, wherein the closure device is urged to close by gravitational force and/or by an actuator.

4. The shut-off valve according to claim 3, wherein the actuator comprises at least one resilient element.

5. The shut-off valve according to claim 1, wherein the inertial mass has a weight between 20 and 80 g.

6. The shut-off valve according to claim 1, wherein the inertial mass has a weight between 30 and 50 g.

7. The shut-off valve according to claim 1, wherein the joint is configured so as to separate the discharge channel from the receiving chamber, in which the inertial mass is received, keeping it outside the discharge channel.

8. The shut-off valve according to claim 1, wherein the joint is at a pivot location positioned between the free end of the rod and the inertial mass.

9. The shut-off valve according to claim 1, wherein the interception zone of the valve body comprises a valve seat and the closure device comprises a valve head which is arranged in the discharge channel and which is provided to occupy a position spaced apart from the valve seat when the closure device is in the open position, and a position in which the valve head is engaged in a sealing manner with the valve seat when the closure device is in the closed position.

10. The shut-off valve according to claim 9, wherein the valve head is arranged in the discharge channel upstream of the valve seat.

11. The shut-off valve according to claim 9, wherein the valve head is arranged in the discharge channel downstream of the valve seat.

12. The shut-off valve according to claim 9, wherein the valve head and/or the valve seat comprise at least one resilient fluid-tight element.

13. The shut-off valve according to claim 12, wherein the resilient fluid-tight element is an annular fluid-tight seal.

14. The shut-off valve according to claim 9, wherein the closure device comprises a pin which is fixedly joined to the valve head and which is arranged along the axis (X) and slidingly movable into the interception zone and which has a free end in the direction away from the valve head, and the oscillating group is supported in a pivoting manner between the rest position, in which the free end of the rod abuts the free end of the pin, maintaining the closure device in the open position, and the safety position, in which the free end of the rod does not abut the free end of the pin, so that the closure device is free to move in translation into the closed position.

15. The shut-off valve according to claim 1, wherein the joint is an oscillating joint.

16. The shut-off valve according to claim 15, wherein the oscillating joint is a ball joint comprising a spherical pin which is fixedly joined to the valve body and a corresponding spherical element which is fixedly joined to the rod and which is arranged along it at a location between the free end of the rod and the inertial mass.

17. The shut-off valve according to at least claim 14, wherein the free end of the pin is tapered.

18. The shut-off valve according to claim 17, wherein the free end of the pin is tapered with a spherical or conical form.

19. The shut-off valve according to claim 1, wherein the free end of the rod is tapered.

20. The shut-off valve according to claim 19, wherein the free end of the rod is tapered with a frustoconical form.

21. The shut-off valve according to claim 1, wherein the closure device is urged to close by at least one resilient element.

22. The shut-off valve according to claim 1, wherein the resilient element is a spring.

23. The shut-off valve according to claim 22, wherein the spring is an expansion spring.

24. The shut-off valve according to claim 18, wherein the valve body has an internal abutment and the resilient element is an expansion spring which has an axis arranged along the axis (X) and which is confined between the valve head and the internal abutment.

25. The shut-off valve according to claim 24, wherein the closure device comprises a shaft which is arranged along the axis (X) in the direction away from the valve head at the side opposite the pin and which moves inside the expansion spring.

26. The shut-off valve according to claim 25, wherein the shaft comprises a shaft portion which is slidingly received in the internal abutment in such a manner that, when the closure device moves between the open and closed positions, the shaft portion slides in the internal abutment.

27. The shut-off valve according to claim 1, wherein the centre of gravity of the inertial mass is located along the axis (X) when the oscillating group is in the rest position and is located outside the axis (X) when the oscillating group is in the safety position.

28. The shut-off valve according to claim 1, wherein the inertial mass is rotationally symmetrical with respect to the axis (X).

29. Use of a shut-off valve constructed according to any one of the preceding claims in a vehicle for intercepting a fluid following an impact which is generated following a collision of the vehicle as a result of an incident.
